(19) United States
(12) Patent Application Publication
(10) Pub. No.: US 2023/0084492 A1
(43) Pub. Date: Mar. 16, 2023

(54) ONTOLOGICAL MODELING METHOD AND SYSTEM, STORAGE MEDIUM AND COMPUTER DEVICE FOR FLOWER PESTS AND DISEASES BASED ON KNOWLEDGE GRAPH

(71) Applicant: Shanghai Ocean University, Shanghai (CN)

(72) Inventors: Ming CHEN, Shanghai (CN); Juezhang ZHU, Shanghai (CN); Xiaotao XI, Shanghai (CN)

(21) Appl. No.: 18/056,163

(22) Filed: Nov. 16, 2022

(30) Foreign Application Priority Data
Aug. 31, 2022 (CN) 202211057227.0

(51) Int. Cl. G06F 16/36; G06F 40/30

(52) U.S. Cl. CPC G06F 16/367; G06F 40/30

(57) ABSTRACT

An ontological modeling method for flower pests and diseases based on knowledge graph, including: extracting multiple property elements of a flower pests and diseases domain from text; constructing an ontology model including a triple unit; tagging a head entity array and a tail entity array of the triple unit; constructing a joint extraction framework model; constructing a knowledge graph-based knowledge extraction framework; and converting a resource description framework (RDF) in the triple unit into a property graph; and storing the property graph in a Neo4J graph database. A system for implementing the ontological modeling method is also provided.

### CROSS-REFERENCE TO RELATED APPLICATIONS

This application claims the benefit of priority from Chinese Patent Application No. 202211057227.0, filed on Aug. 31, 2022. The content of the aforementioned application, including any intervening amendments thereto, is incorporated herein by reference in its entirety.

### TECHNICAL FIELD

This application relates to control and prevention of flower pests and diseases, and more particularity to an ontological modeling method and system for flower pests and diseases based on knowledge graph.

### BACKGROUND

Flower pests and diseases are leading causes for poor flower production efficiency, and will seriously affect the economic benefits. Nowadays, there is a considerable amount of flower pests and diseases control knowledge available in the network, and traditional relational database management methods cannot display and store this knowledge effectively, and fail to fuse heterogeneous data, express the data relationship efficiently and refine knowledge. The existing researches mainly focus on control strategy, control knowledge and mechanism of a certain type or class of flower pests and diseases, and sorting and integration of the entity relationships in the knowledge of flower pests and diseases are absent, failing to form a knowledge system and leading to redundancy. Consequently, there is still a lack of efficient tools and methods for knowledge management and modeling of flower pests and diseases.

Knowledge graph has been applied to the investigation of plant pests and diseases. Regarding those domain ontology-oriented researches, a domain ontology model of pests and diseases is constructed based on agricultural thesaurus and related literatures to overcome actual problems. Some researches focus on domain data, in which after analyzing the domain data, entities and relationships in the data are extracted to realize the knowledge refinement. It has also been reported about the use of bibliometric strategies to build a knowledge graph through keyword clustering to visualize pests and diseases researches.

Unfortunately, the above-mentioned researches all fail to take the environmental factor, which is crucial for pests and diseases control, into consideration, and cannot enable the intelligent and systematic management. Moreover, with respect to the knowledge graph construction and unstructured data extraction, the generalization and accuracy still remain to be improved.

### SUMMARY

An object of the present disclosure is to provide an ontological modeling method for flower pests and diseases based on knowledge graph, in which factors associated with flower pests and diseases control including environmental factor are extracted, and an ontology model of the flower pests and diseases is constructed by using the existing flower pests and diseases knowledge system, and stored using a resource description framework (RDF) graph. Further, in the analysis of literature corpora of flower pests and diseases, the tagging problem of nested head and tail entities is overcome through a head-tail entity separation “01” tagging method. Semantic features are extracted by means of a lite bidirectional encoder representation from transformers (ALBERT pre-training model, and a CasposRel model combining a part-of-speech (POS) feature vector and a cascade tagging model is proposed to form an extraction framework. A relationship tagger is constructed and trained to build a head-tail entity mapping method, so as to achieve the joint extraction of triples in a large amount of flower pests and diseases text. Meanwhile, based on the ontology model, a custom resource description framework (RDF) graph to property graph (RDF2PG) mapping method is used to store the extracted triples in a Neo4J graph database according to an ontology structure in the RDF graph, enabling the storage and management of flower pests and diseases knowledge. According to the flower pests and diseases knowledge, the most susceptible conditions for various types of flowers can be obtained to prevent the flower pests and diseases. The ontological modeling method provided herein provides support for intelligent diagnosis, decision making and question answering of flower pests and diseases, facilitating improving the prevention and control efficiency and flower production. Another object of the present disclosure is to provide a corresponding ontological modeling system.

Technical solutions of the present disclosure are described as follows.

In a first aspect, this application provides an ontological modeling method for flower pests and diseases based on knowledge graph, comprising:

(S1) extracting a plurality of property elements of a flower pests and diseases domain from text;

(S2) constructing an ontology model of the flower pests and diseases domain, wherein the ontology model comprises a triple unit;

(S3) tagging a head entity array of the triple unit and a tail entity array of the triple unit;

(S4) constructing a joint extraction framework model based on the head entity array, the tail entity array and a relationship between the head entity array and the tail entity array;

(S5) constructing, by means of a pre-trained language representation model, a knowledge graph-based knowledge extraction framework; and

(S6) converting an RDF in the triple unit into a property graph; and storing the property graph in a Neo4J graph database.

With reference to related documents, the modeling method provided herein constructs the ontology model for basic flower pests and diseases control, which has taken environment influence into consideration. The environment influence is not only important for flower pests and diseases control, but also flower pests and diseases prevention in time to further reduce flower loss. The RDF graph is configured to store the ontology structure. Based on the custom RDF2PG mapping method, a extracted triple is stored into the Neo4J graph database according to a structure of the ontology model without going through other storage methods, standardizing the managed knowledge and improving a storage efficiency and automatic graph construction capability.

In some embodiments, a property of the triple unit comprises data type property and object property.

In some embodiments, step (S3) comprises:

tagging a head start position of the head entity array and a head end position of the head entity array with a first tag, respectively; and tagging a character between the head start position and the head end position with a second tag, wherein the first tag is different from the second tag; and

tagging a tail start position of the tail entity array and a tail end position of the tail entity array with a third tag, respectively; and tagging a character between the tail start position and the tail end position with a fourth tag, wherein the third tag is different from the fourth tag.

In some embodiments, step (S4) comprises:

with regard to each character vector in the text, respectively calculating the head start position and the head end position according to the following formulas:

pᵢ^{start}^{_{sub}}=σ(Wₛₜₐᵣₜcᵢ+bₛₜₐᵣₜ) (1); and

pᵢ^{end}^{_{sub}}=σ(W_{end}cᵢ+b_{end}) (2);

wherein cᵢ is a character vector in the text; pᵢ^{start}^{_{sub}} is a possible position of the head start position; pᵢ^{end}^{_{sub}} is a possible position of the head end position; σ is a Sigmoid activation function; Wₛₜₐᵣₜ is a start training weight; W_{end} is an end training weight; bₛₜₐᵣₜ is a start training bias; and b_{end} is an end training bias.

In some embodiments, the modeling method further comprises:

building mapping between each head entity array and a specific annotator of each relationship; and calculating a tail start position and a tail end position of a tail entity array of each relationship according to the following formulas:

p_{i,r}^{start}^{_{obj}}=σ(Wₛₜₐᵣₜ(cᵢ+subₖ+posᵢ)+bₛₜₐᵣₜ) (3); and

p_{i,r}^{end}^{_{obj}}=σ(W_{end}(cᵢ+subₖ+posᵢ)+b_{end}) (4);

wherein r represents relationship type; subₖ is vector representation of a k-th head entity feature vector; p_{i,r}^{start}^{_{obj}} is a possible position of the tail start position; p_{i,r}^{end}^{_{obj}} is a possible position of the tail end position; and posᵢ represents a POS vector of a word in which the i-th character is located.

In some embodiments, step (S5) comprises:

performing POS tagging by means of a Jieba word segmentation tool, and embedding a POS vector; and

subjecting a vector of a head entity character and a character sequence vector containing sentence information to fusion to obtain a vector of a character with a position different from the head entity character, expressed as:

c̅ᵢ=cᵢ+posᵢ+subₖ (5)

wherein cᵢ represents an encoded character vector of a pre-trained language representation model of the i-th character.

In some embodiments, step (S6) comprises:

performing reading and reasoning on the text by using a Jena application index (API); and taking the Neo4J graph database as a storage tool for the property graph.

In some embodiments, step (S6) comprises:

extracting a triple;

reading, by the Jena API, the ontology model;

acquiring entity conceptual information; traversing the triple; and searching a head entity concept and a tail entity concept corresponding to a triple relationship in the triple in the ontology model;

acquiring entity property information; and searching a corresponding property name and a corresponding property type in the ontology model according to the head entity concept and the tail entity concept; and

creating a password statement; and storing the triple.

In a second aspect, this application provides an ontological modeling system for flower pests and diseases based on knowledge graph, wherein the ontological modeling system is configured to implement the above-mentioned ontological modeling method.

In a third aspect, this application provides a non-transitory computer readable storage medium, wherein the non-transitory computer readable storage medium is configured to store a computer program; and the computer program is configured to be executed by a processor to implement the above-mentioned ontological modeling method.

In a fourth aspect, this application provides a computer device, comprising:

a memory; and

a processor;

wherein the memory is configured to store a computer program; and the computer program is configured to be executed by the processor to implement the above-mentioned ontological modeling method.

The additional aspects and advantages of the present disclosure will become apparent below with reference to the description or practice.

### BRIEF DESCRIPTION OF THE DRAWINGS

The features and advantages of the present disclosure will become apparent and easily understood from the following description with reference to the accompanying drawings.

FIG. 1 is a structural block diagram of an ontological modeling system for flower pests and diseases based on knowledge graph according to an embodiment of the present disclosure;

FIG. 2 schematically shows an ontology model of a flower pests and diseases domain according to an embodiment of the present disclosure;

FIG. 3 shows a tagging scheme according to an embodiment of the present disclosure;

FIG. 4 is a diagram of a joint extraction framework model according to an embodiment of the present disclosure;

FIG. 5 is a flow chart of a RDF2PG mapping algorithm according to an embodiment of the present disclosure; and

FIG. 6 is a structural block diagram of a computer device according to an embodiment of the present disclosure.

### DETAILED DESCRIPTION OF EMBODIMENTS

The embodiments of this application will be described in detail below with reference to the accompanying drawings, and throughout the drawings, the same or similar reference numerals refer to the same or similar elements or elements with the same or similar functions. It should be noted that described above are merely illustrative of the present disclosure, and not intended to limit the present disclosure.

The knowledge graph is a method proposed by Google in 2012 to effectively represent relationships between data through the semantic network. At present, the knowledge graph has attracted a lot attention to manage domain knowledge that is incompatible with traditional knowledge management methods.

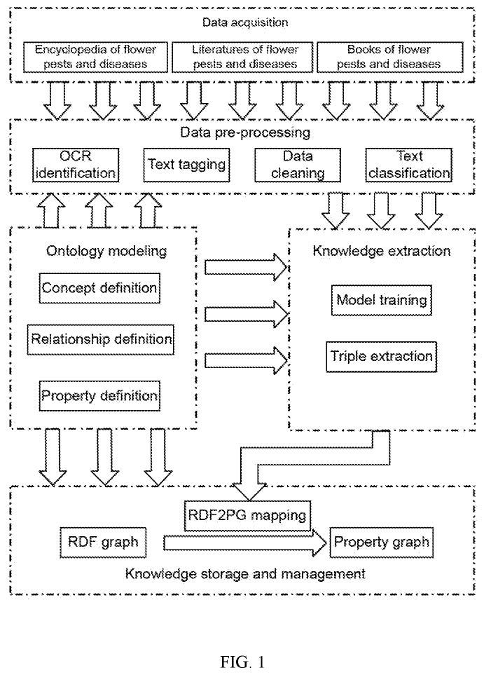

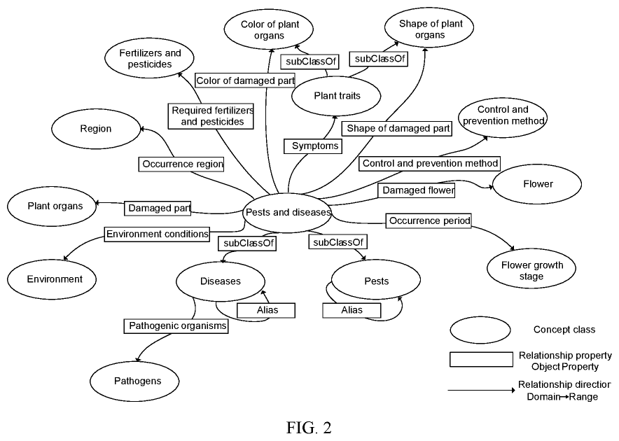

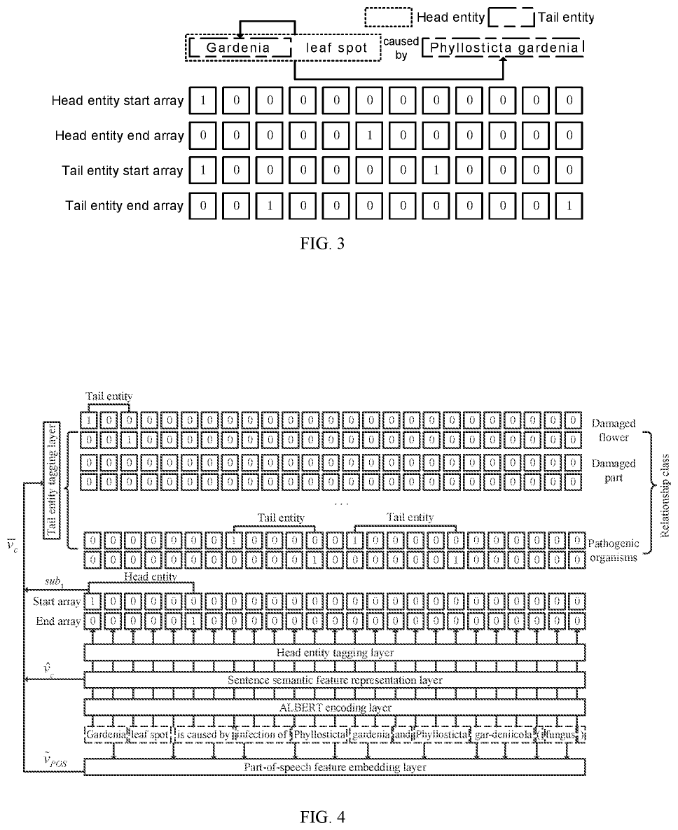

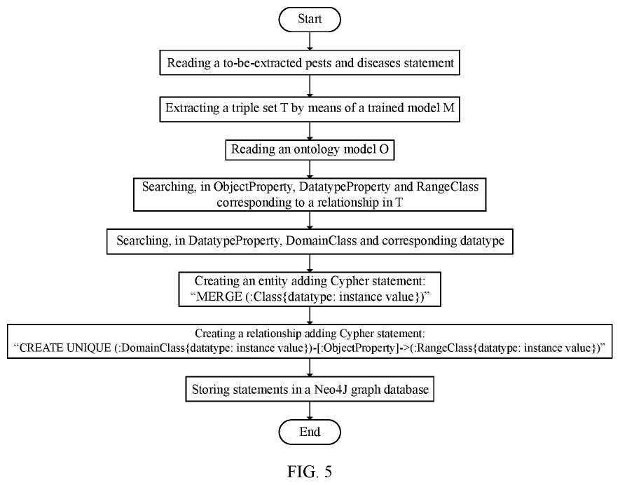

Shown in FIG. 1 is a structural block diagram of an ontological modeling system for flower pests and diseases based on knowledge graph; FIG. 2 is an ontology model of a flower pests and diseases domain; FIG. 3 shows a tagging scheme; FIG. 4 is a diagram of a joint extraction framework model; and FIG. 5 is a flow chart of a RDF2PG mapping algorithm.

Referring to FIGS. 1-5, an ontological modeling method for flower pests and diseases based on knowledge graph includes the following steps.

(S1) Multiple property elements of a flower pests and diseases domain are extracted from text.

Specifically, ten types of property elements of the flower pests and diseases domain, including flower name, flower growth stage, plant organs, region, pests and diseases, fertilizers and pesticides, control method, symptom, environment and pathogen, are subjected to ontology concept property extraction to be taken as a key concept.

(S2) An ontology model of the flower pests and diseases domain is constructed, where the ontology model includes a triple unit.

Specifically, the flower pests and diseases domain is constructed by means of the protégé ontology modeling tool. Relations between concepts are shown in FIG. 1. The flower pests and diseases domain shows relations between concepts in flower pests and diseases domain, in which a subclass is represented by subClassOf. For example, a triple (diseases, rdfs:subClassof, pests and disease) represents that diseases is a subclass of pests and diseases. The flower pests and diseases domain includes data property represented by DatatypeProperty, and object property represented by ObjectProperty. The DatatypeProperty represents an object and a type of the data property. For example, (diseases, diseases name, xsd:string) represents that a domain of definition of a diseases name of the diseases is “disease” type, and a range is string type. The ObjectProperty represents relationship property between types. For example, (pests and diseases, damaged part, plant organs) represents that a domain of definition of the “damaged part” is “pests and disease”; and a range thereof is “plant organs”. The defined relationships and properties are constraints and regulations for the instance data.

(S3) A head entity array of the triple unit and a tail entity array of the triple unit are tagged, respectively.

Specifically, a head start position of the head entity array and a head end position of the head entity array are tagged with a first tag, respectively. A character between the head start position and the head end position is tagged with a second tag, where the first tag is different from the second tag.

A tail start position of the tail entity array and a tail end position of the tail entity array are tagged with a third tag, respectively. A character between the tail start position and the tail end position is tagged with a fourth tag, where the third tag is different from the fourth tag.

In an embodiment, a triple is tagged by using a head-tail entity separation tagging method with a “01” tagging method. A tagging scheme is performed as follows.

(1) Performing of Head-Tail Entity Separation Tagging Method

A tagging sequence array is divided into a head entity sequence array and a tail entity sequence array. Compared with the traditional method of tagging head and tail entity in a single sequence array, the head entity and tail entity are separated into two arrays, so as to overcome defects of the nested head entities and tail entities tagging method and the overlapping head and tail entities tagging method. In addition, text of flower pests and diseases is acquired from internet and literature, and semantic triple tagging is performed on the text according to the ontology model constructed in steps (S1)-(S2).

(2) Construction of “01” Tagging Mode

An entity start array represents an entity start position, and an entity end array represent an entity end position. For the input text, two arrays having the same length as the input text and all elements of “0” are created, and then initialized. According to a pre-tagged entity content, a head position in a corresponding array and a tail position of the entity in the corresponding array are tagged as “1”, respectively. If there are multiple entities in one sentence, a part between an “1” in the entity start array and “1” in the nearest entity end array is considered as an entity according to the proximity principle. Compared to the traditional “BIO” tagging method, the “01” tagging method requires only dichotomous tag prediction and is free from predicting multiple tag classes, which reduces the prediction difficulty. Moreover, the “01” tagging method merely tags boundaries of the head position of the entity and tail position of the entity, reducing an entity errors or missing probability during prediction. For a single-word entity, a better representation can be made without introducing additional tagging symbols to tag separately to further increase the predicted tag class and the prediction difficulty. A tagging scheme for gardenia leaf spot is shown in FIG. 3.

(S4) A joint extraction framework model based on the head entity array, the tail entity array and a relationship between the head entity array and the tail entity array is constructed.

Specifically, a CasposRel triple is constructed for the joint extraction framework model, that is, a relationship between entities is extracted simultaneously. For each character vector in an input sentence, a possible position of the head start position is calculated according to formula (1), and a possible position of the head end position is calculated according to formula (2):

pᵢ^{start}^{_{sub}}=σ(Wₛₜₐᵣₜcᵢ+bₛₜₐᵣₜ) (1); and

pᵢ^{end}^{_{sub}}=σ(W_{end}cᵢ+b_{end}) (2);

where cᵢ is a character vector in the text; pᵢ^{start}^{_{sub}} is a possible position of the head start position; pᵢ^{end}^{_{sub}} is a possible position of the head end position; σ is a Sigmoid activation function; Wₛₜₐᵣₜ is a start training weight; W_{end} is an end training weight; bₛₜₐᵣₜ is a start training bias; and b_{end} is an end training bias.

Mapping between each head entity array and a specific annotator of each relationship is built. A possible position of a tail start position p_{i,r}^{start}^{_{obj}} of each relationship is calculated according to formula (3), and a possible position of a tail end position of each relationship is calculated according to formula (4):

p_{i,r}^{start}^{_{obj}}=σ(Wₛₜₐᵣₜ(cᵢ+subₖ+posᵢ)+bₛₜₐᵣₜ) (3); and

p_{i,r}^{end}^{_{obj}}=σ(W_{end}(cᵢ+subₖ+posᵢ)+b_{end}) (4);

where r represents relationship type; subₖ is vector representation of a k-th head entity feature vector; p_{i,r}^{start}^{_{obj}} is a possible position of the tail start position; p_{i,r}^{end}^{_{obj}} is a possible position of the tail end position; and posᵢ represents a part-of-speech (POS) vector of a word in which the i-th character is located.

Characters, which are taken as semantic units, are combined with POS features, and a word feature and a speech feature are subjected to fusion, so as to obtain a part-of-word-speech hybrid character vector. A tag corresponding to each character is determined according to a preset activation threshold.

(S5) A knowledge graph-based knowledge extraction framework is constructed by means of a pre-trained language representation model.

Specifically, the ALBERT pre-trained model is used as an encoding layer, and is configured to extract a text character to obtain a character sequence vector having rich semantic information. The character sequence vector is taken as an input to calculate the most possible head entity boundary through a head entity annotator. The entity start position is represented by “1” in the entity start array, and the entity end position is represented by “1” in the entity end array. By means of a Jieba word segmentation tool, POS tagging is performed and a POS vector is embedded. A vector of a head entity character subₖ and a character sequence vector containing sentence information are subjected to fusion to obtain a vector of an i-th character, expressed as formula (5):

c̅ᵢ=cᵢ+posᵢ+subₖ (5)

where cᵢ represents an ALBERT encoded character vector of the i-th character; posᵢ represents a POS vector of a word in which the i-th character is located; and subₖ is vector representation of a k-th head entity feature vector.

A character vector after fusion v̅_{c}={c̅₁, c̅₂ . . . , c̅ₙ} is input into the specific annotator of each relationship to perform tail entity tagging, which is specifically shown in structure diagram of knowledge extraction framework.

(S6) A RDF in the triple unit is converted into a property graph. The property graph is stored in a Neo4J graph database.

Specifically, the constructed triple is directly stored in a property graph through the RDF2PG mapping algorithm, which provides a management and storage method for the flower pests and diseases knowledge model. In order to ensure timeliness of knowledge and knowledge graph-based knowledge discovery, the knowledge graph is required to be updated in time and controlled in storage fine granularity. This application provides the RDF2PG mapping method which stores the extracted triple directly into the property graph according to an ontology structure stored in a resource description framework graph. Reading and reasoning are performed on the text by using a Jena application index (API). The Neo4J is configured as a property graph storing tool.

The ontological modeling method provided herein provides a tool and method for knowledge extraction, knowledge management and knowledge modeling of flower pests and diseases control knowledge bases, a new knowledge graph-based mode and method of knowledge discovery, knowledge storage and knowledge management for pests and diseases expert system, and a technical support for background knowledge management and knowledge discovery of diagnostic expert system for flower pests and diseases control, online diagnosis and intelligent applications.

For text characteristic of the flower pests and diseases domain, the ontological modeling method provided herein represents semantic by multi-feature, which can realize joint extraction of entities and relations, reduce the knowledge extraction and refinement cost, and allows the knowledge graph to be constructed quickly and updated in time. The knowledge management and storage model is combined with graph database to realize the RDF2PG mapping method, in which the extracted triple is directly stored into the property graph according to the ontology structure stored in the RDF graph, providing a new model and method for knowledge management and knowledge storage of flower pests and diseases.

In an embodiment, referring to FIG. 5, a RDF2PG mapping algorithm includes the following steps.

(S6.1) Triple extraction

To-be-extracted text is input into a CasposRel model to obtain the triple T.

(S6.2) Reading of ontology model

The ontology model O is subjected to reading by using the Jena API.

(S6.3) Acquisition of entity conceptual information

The triple T extracted in step (S6.1) is traversed. A head entity concept DomainClass corresponding to a triple relationship ObjectProperty and a tail entity concept RangeClass corresponding to the triple relationship ObjectProperty are searched in the triple T.

(S6.4) Acquisition of Entity property information A property name DatatypeProperty corresponding to the head entity concept DomainClass obtained in step (S6.3) and a property type Range corresponding to the tail entity concept RangeClass obtained in step (S6.3) are searched in the ontology model O.

(S6.5) Creation of Cypher statement and triple storage

According to the triple obtained in steps (S6.1)-(S6.4) and a semantic model corresponding to the triple in the ontology model, an entity adding Cypher statement “MERGE (:Class{datatype:instance value}), and a relationship adding Cypher statement: CREATE UNIQUE (:DomainClass{datatype:instance value})-[: ObjectProperty]->(:RangeClass{datatype:instance value})” are created. Data is stored in the Neo4J graph database to store and manage knowledge.

### Embodiment

Described is a specific embodiment to illustrate the modeling method provided herein.

721 documents, covering over 160 species of flowers, symptoms caused by over 170 species of pests, environmental conditions for the occurrence of diseases and pests and diseases control methods of are summarized from “Flower pests and diseases control”, “Flower pests and diseases control book: color pictures”, “Flower and tree pests and diseases control atlas” and Baidu Encyclopedia, and exemplarily illustrated herein.

(S1) Extraction of elements of the flower pests and diseases domain

Ten types of elements, including flower name, flower growth stage, plant organs, region, pests and diseases, fertilizers and pesticides, control method, symptom, environment and pathogen, are taken as a key concept.

(S2) Construction of ontology model of flower pests and diseases

By means of the protégé ontology modeling tool, relations are built, including: (pests and diseases, environment conditions, environment), (pests and diseases, damaged part, plant organs), (pests and diseases, occurrence region, region), (pests and diseases, required fertilizers and pesticides, fertilizers and pesticides), (pests and diseases, color of damaged part, color of plant organs), (pests and diseases, symptom, plant traits), (pests and diseases, shape of damaged part, shape of plant organs), (pests and diseases, control method, control method), (pests and diseases, suffered flower, flower), (pests and diseases, occurrence period, flower growth stage), (diseases, alias, disease), (diseases, pathogen of occurrence, pathogen) and (pests, alias, pest). A DatatypeProperty property of each class is constructed, such as (diseases, diseases name, string) and (pathogen, pathogen name, string).

(S3) Triple tagging

With Gardenia leaf spot as an example, the tagging result can be expressed as {“text”: “Gardenia leaf spot is caused by infection of Phyllosticta gardenia and Phyllosticta gar-deniicola (fungus)”, “triple_list”:[“Gardenia leaf spot”, “pathogenic organism”, “Phyllosticta”]}.

(S4) Tagging of entities in the triple

With the Gardenia leaf spot as an example, the tagging scheme is schematically shown in FIG. 3.

(S5) Construction of CasposRel extraction framework

With the Gardenia leaf spot as an example, a joint extraction framework model is shown in FIG. 4.

(S6) Knowledge is managed and stored.

(S6.1) Triple extraction

Text “gardenia leaf spot is caused by infection of Phyllosticta gardenia and Phyllosticta gar-deniicola (fungus)” is taken as an example. By means of the knowledge graph-based knowledge extraction framework built in step (S5), a triple (“gardenia leaf spot”, “pathogenic organism”, “Phyllosticta”) is extracted.

(S6.2) Reading of ontology model

By means of the Jena API, the ontology model O constructed in step (S2) is read.

(S6.3) Acquisition of entity conceptual information A head entity concept DomainClass “disease” and a tail entity concept RangeClass “pathogen” both corresponding to a relationship “pathogen of occurrence” are searched in the ontology model O.

(S6.4) Acquisition of entity property information

A DatatypeProperty corresponding to “disease” and a DatatypeProperty corresponding to “pathogen” are searched, respectively. A range of “diseases name” and that of “pathogen name” are obtained, and both are string.

(S6.5) Creation of Cypher statement and triple storage

An entity adding Cypher statement “MERGE (:disease{diseases name:‘Gardenia leaf spot’}), MERGE (:pathogen{pathogen name:‘Phyllosticta’})” is created. A relationship adding Cypher statement “CREATE UNIQUE (:disease{diseases name:‘Gardenia leaf spot’})-[:pathogenic organism]->(: pathogen{pathogen name:‘Phyllosticta’})” is created. The triple (“Gardenia leaf spot”, “Pathogenic organism”, “Phyllosticta”) is stored.

This application also provides a system for implementing the above-mentioned ontological modeling method.

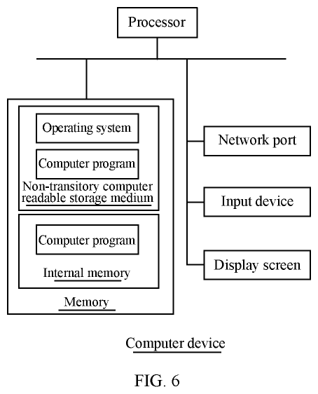

Referring to FIG. 6, a computer device includes a processor, a memory, a network port, an input device and a display screen connected through a system bus. The memory includes a non-transitory computer readable storage medium and an internal memory. The non-transitory computer readable storage medium is configured to store an operating system and a computer program. The computer program is configured to be executed by the processor to implement a data communication control method. The internal memory can also be configured to store a computer program which is configured to be executed by the processor to implement a data communication control method. The display screen is a liquid crystal display (LCD) screen or an electronic ink screen. The input device is a touch layer overlaid on the display screen, or a button, track ball or touchpad arranged on a shell of the computer device, or an external keyboard, trackpad, or mouse.

It should be understood that the computer device shown in FIG. 6 is merely an embodiment of the disclosure, and are not intended to limit the disclosure. Other embodiments with more or fewer components, or combinations of certain components, or different arrangements of components shall fall within the scope of the present disclosure.

In an embodiment, the ontological modeling system provided herein can be implemented as a computer program, which can be executed on the computer device shown in FIG. 6. The memory of the computer device is configured to store various program modules, structural frameworks, models and the like which form the ontology modeling system, for example, the structural framework shown in FIG. 1, the ontology model shown in FIG. 2, the tagging scheme shown in FIG. 3 and the joint extraction framework model shown in FIG. 4. The computer program formed by program modules allows the processor to execute the ontological modeling method provided herein.

In an embodiment, a non-transitory computer readable storage medium is provided, where the non-transitory computer readable storage medium is configured to store a computer program; and the computer program is configured to be executed by a processor to implement the ontological modeling method.

In an embodiment, a computer device includes a memory and a processor. The memory is configured to store a computer program; and the computer program is configured to be executed by the processor to implement the ontological modeling method

As used herein, terms “an embodiment”, “some embodiments”, “example”, “specific example” and “some examples” means that the specific features, structures, materials, or characteristics described with reference thereto are included in at least one embodiment or example of the present disclosure. The above terms are merely exemplary, and do not refer to the same embodiment or example. Moreover, the features, structures, materials, or characteristics described may be combined in a suitable manner in any one or more embodiments or examples.

Described above are merely illustrative of the disclosure, and are not intended to limit the disclosure. Although the disclosure has been illustrated and described in detail above, it should be understood that those skilled in the art could still make some modifications and changes to the embodiments of the disclosure. Those modifications, replacements and variations made by those skilled in the art based on the content disclosed herein without departing from the scope of the disclosure shall fall within the scope of the present disclosure defined by the appended claims.

What is claimed is:

1. An ontological modeling method for flower pests and diseases based on knowledge graph, comprising:
(S1) extracting a plurality of property elements of a flower pests and diseases domain from text;
(S2) constructing an ontology model of the flower pests and diseases domain, wherein the ontology model comprises a triple unit;
(S3) tagging a head entity array of the triple unit and a tail entity array of the triple unit;
(S4) constructing a joint extraction framework model based on the head entity array, the tail entity array and a relationship between the head entity array and the tail entity array;
(S5) constructing, by means of a pre-trained language representation model, a knowledge graph-based knowledge extraction framework; and
(S6) converting a resource description framework (RDF) in the triple unit into a property graph; and storing the property graph in a Neo4J graph database.

2. The ontological modeling method of claim 1, wherein a property of the triple unit comprises data property and object property.

3. The ontological modeling method of claim 1, wherein step (S3) comprises:
tagging a head start position of the head entity array and a head end position of the head entity array with a first tag, respectively; and tagging a character between the head start position and the head end position with a second tag, wherein the first tag is different from the second tag; and
tagging a tail start position of the tail entity array and a tail end position of the tail entity array with a third tag, respectively; and tagging a character between the tail start position and the tail end position with a fourth tag, wherein the third tag is different from the fourth tag.

4. The ontological modeling method of claim 3, wherein step (S4) comprises:
with regard to each character vector in the text, respectively calculating the head start position and the head end position according to the following formulas:
pᵢ^{start}^{_{sub}}=σ(Wₛₜₐᵣₜcᵢ+bₛₜₐᵣₜ) (1); and
pᵢ^{end}^{_{sub}}=σ(W_{end}cᵢ+b_{end}) (2);
wherein cᵢ is a character vector in the text; pᵢ^{start}^{_{sub}} is a possible position of the head start position; pᵢ^{end}^{_{sub}} is a possible position of the head end position; σ is a Sigmoid activation function; Wₛₜₐᵣₜ is a start training weight; W_{end} is an end training weight; bₛₜₐᵣₜ is a start training bias; and b_{end} is an end training bias.

5. The ontological modeling method of claim 4, further comprising:
building mapping between each head entity array and a specific annotator of each relationship; and calculating a tail start position and a tail end position of a tail entity array of each relationship according to the following formulas:
p_{i,r}^{start}^{_{obj}}=σ(Wₛₜₐᵣₜ(cᵢ+subₖ+posᵢ)+bₛₜₐᵣₜ) (3); and
p_{i,r}^{end}^{_{obj}}=σ(W_{end}(cᵢ+subₖ+posᵢ)+b_{end}) (4);
wherein r represents relationship type; subₖ is vector representation of a k-th head entity feature vector; p_{i,r}^{start}^{_{obj}} is a possible position of the tail start position; p_{i,r}^{end}^{_{obj}} is a possible position of the tail end position; and posᵢ represents a part-of-speech (POS) vector of a word in which the i-th character is located.

6. The ontological modeling method of claim 5, wherein step (S5) comprises:
performing POS tagging by means of a Jieba word segmentation tool, and embedding a POS vector; and
subjecting a vector of a head entity character and a character sequence vector containing sentence information to fusion to obtain a vector of a character with a position different from the head entity character, expressed as:
c̅ᵢ=cᵢ+posᵢ+subₖ (5)
wherein cᵢ represents an encoded character vector of a pre-trained language representation model of the i-th character.

7. The ontological modeling method of claim 1, wherein step (S6) comprises:
performing reading and reasoning on the text by using a Jena application index (API); and taking the Neo4J graph database as a storage tool for the property graph.

8. The ontological modeling method of claim 7, wherein step (S6) comprises:
extracting a triple;
reading, by the Jena API, the ontology model;
acquiring entity conceptual information; traversing the triple; and searching a head entity concept and a tail entity concept corresponding to a triple relationship in the triple in the ontology model;
acquiring entity property information; and searching a corresponding property name and a corresponding property type in the ontology model according to the head entity concept and the tail entity concept; and
creating a password statement; and storing the triple.

9. An ontological modeling system for flower pests and diseases based on knowledge graph, wherein the ontological modeling system is configured to implement the ontological modeling method of claim 1.

10. A non-transitory computer readable storage medium, wherein the non-transitory computer readable storage medium is configured to store a computer program; and the computer program is configured to be executed by a processor to implement the ontological modeling method of claim 1.

11. A computer device, comprising:
a memory; and
a processor;
wherein the memory is configured to store a computer program; and the computer program is configured to be executed by the processor to implement the ontological modeling method of claim 1.
